(19) United States
(12) Patent Application Publication
(10) Pub. No.: US 2005/0254779 A1
(43) Pub. Date: Nov. 17, 2005

(54) Video signal playback system receiving remote controller control command

(75) Inventor: Isao Naka, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/126,411

(22) Filed: May 11, 2005

(30) Foreign Application Priority Data
May 12, 2004 (JP) P2004-142587

(51) Int. Cl. H04N 5/781

(52) U.S. Cl. 386/46; 386/125

(57) ABSTRACT

A video signal playback system for reproducing recorded data read out from a recording medium to image-display a video signal of the recorded data on a video display unit of a television receiver or a monitor device, includes a remote sensor receiving unit that receives a remote controller control command transmitted as an optical signal from a remote controller, a main body display unit that displays a status of the apparatus, and a control unit that controls the entire apparatus on a basis of an instruction by the command. The control unit includes a flashing controlling function of changing a brightness level of an image being displayed on the video display unit and/or a brightness level of information being displayed on the main body display unit to at least one of higher and lower levels than its normal level whenever the control unit detects an input of the command.

### BACKGROUND OF THE INVENTION

1. Field of the Invention

This invention relates to a video signal playback system such as a DVD player or VCR, for reproducing recorded data read out from a recording medium through remote control by a remote controller and image-displaying a video signal of the recorded data on a video display unit.

2. Description of the Related Art

In such a video signal playback system, various operation commands or instructions are given through remote control by the remote controller to image-display the video signal read out from the recording medium on a television receiver or monitor device. The remote controller transmits a remote controller control command in the form of an invisible infrared ray signal. Therefore, immediately after the remote controller operation, if the displayed image on the video display unit remains unchanged, an operator or user cannot know whether or not the remote controller control command from the remote controller has been exactly received by the receiver, and so he or she has feelings of anxiety. For example, where the user operates the remote controller for a light receiving segment provided on the front face of the receiver in an oblique direction or from a relatively great distance, where a shielding object which blocks the infrared ray signal is located between the remote controller and playback system, or where a battery which is a driving source for the remote controller has been consumed, although the user has operated the remote controller, the remote controller control command is not received by the light receiving segment of the playback system. In addition, since the user does not often know the command functions of all the operation keys, he or she will repeat the operation again and again. Particularly, if the battery has been consumed, the operator cannot know whether the battery has been consumed or the playback system itself has broken down.

In order to avoid such an inconvenience, conventionally, there has been proposed a video signal playback system which is provided with an auditory noticing means and/or a visual noticing means. The auditory noticing means notices using buzzer or synthesized voice, and the visual noticing means notices using a lamp or liquid crystal display device whether or not the remote controller control command transmitted from the remote controller has been exactly received by the playback system (for example, see JP-A-7-14786). Further, conventionally, there has also been proposed a video signal playback system which image-displays whether or not the remote controller control command has been received, using an “on-screen-display function” for image-displaying the information such as the presence or absence of a reproducing operation and disk insertion or on-off of the electric power.

However, the video signal playback system provided with the auditory noticing means and visual noticing means must be provided with, in addition to the two kinds of noticing means, a changeover switch for these two kinds of noticing means. This makes the structure complicate and increases the production cost. Particularly, the video signal playback system which represents voice recognition using the synthesized voice requires an expensive piezo-speaker so that the production cost is further increased. On the other hand, video signal playback system which image-displays whether or not the remote controller control command has been received, using an “on-screen-display function” can enhance its added value, but its production cost is further increased.

In view of the above problems involved in the prior arts, this invention has been accomplished. An object of this invention is to provide a video signal playback system which adopts a low-cost configuration using an ordinary hardware mechanism as it is and also surely informs an operator whether or not the remote controller control command from the remote controller has been received.

### SUMMARY OF THE INVENTION

According to aspect 1 of the invention, a video signal playback system for reproducing recorded data read out from a recording medium to image-display the video signal of the recorded data on a video display unit of a television receiver or a monitor device, includes a remote sensor receiving unit for receiving a remote controller control command transmitted as an optical signal from a remote controller, a fluorescent image panel for displaying a status of the apparatus, and a control unit for controlling the entire apparatus on the basis of an instruction by the remote controller control command. Preferably, the control unit has at least one of a flashing controlling function of changing the brightness level of an image being displayed on the video display unit to levels higher and lower than its normal level, or another flashing controlling function of changing the brightness level of information being displayed on the fluorescent image panel to levels higher and lower than its normal level whenever the control unit detects inputting of the remote controller control command.

According to aspect 2 of the invention, a video signal playback system for reproducing recorded data read out from a recording medium to image-display the video signal of the recorded data on a video display unit of a television receiver or a monitor device, includes a remote sensor receiving unit for receiving a remote controller control command transmitted as an optical signal from a remote controller, and a control unit for controlling the entire apparatus on the basis of an instruction by the remote controller control command. Preferably, the control unit has a flashing controlling function of changing the brightness level of an image being displayed on the video display unit to levels higher and lower than its normal level whenever the control unit detects inputting of the remote controller control command.

The invention of aspect 3 is the video signal playback system characterized in that in the video signal playback system of aspect 2, the control unit sequentially creates a video signal brightness-up command or a video signal brightness-down command to be supplied to a decoder circuit.

According to aspect 4 of the invention, a video signal playback system for reproducing recorded data read out from a recording medium to image-display the video signal of the recorded data on a video display unit of a television receiver or a monitor device, includes a remote sensor receiving unit for receiving a remote controller control command transmitted as an optical signal from a remote controller, a fluorescent image panel for displaying a status of the apparatus, and a control unit for controlling the entire apparatus on the basis of an instruction by the remote controller control command. Preferably, the control unit has a flashing controlling function of changing the brightness level of information being displayed on the fluorescent image panel to levels higher and lower than its normal level whenever the control unit detects inputting of the remote controller control command.

The invention of aspect 5 is the video signal playback system characterized in that in the video signal playback system of aspect 4, the control unit sequentially creates a display-driver brightness-up command or a display-driver brightness-down command to be supplied to a display driver circuit for display-controlling the fluorescent image panel.

In the invention described in claim 1, whenever a remote controller control command is received from a remote controller, after the brightness level of an image being displayed on a video display unit of a television receiver has been changed to a higher level, it is changed to a lower level. For this reason, an operator can clearly visually recognize changes in the brightness of the image on the video display unit and so surely recognize that the remote controller control command has been received. Otherwise, whenever a remote controller control command is received from a remote controller, after the brightness level of information being displayed on a fluorescent image panel has been changed to a higher level, it is changed to a lower level. For this reason, the operator can clearly visually recognize changes in the brightness of the information being displayed and so surely recognize that the remote controller control command has been received. In addition, the video signal playback system requires no addition of any circuit in the recognition/display on whether or not the remote controller control command has been received, and can be realized in a low-cost configuration using the existing configuration as it is as hardware and simply changing a part of the control program of the control unit.

In the invention described in claim 2, whenever a remote controller control command is received from a remote controller, after the brightness level of an image being displayed on a video display unit of a television receiver has been changed to a higher level, it is changed to a lower level. For this reason, an operator can clearly visually recognize changes in the brightness of the image on the video display unit and so surely recognize that the remote controller control command has been received.

In the invention described in claim 3, in order to change the brightness level of the image being displayed on the video display unit of e.g. the television receiver, a part of the control program to be executed by the control unit has only to be changed to create the video signal brightness-up command and the video signal brightness-down command. No addition of the circuit is required, thus giving rise to no increase in the production cost.

In the invention described in claim 4, whenever a remote controller control command is received from a remote controller, after the brightness level of information being displayed on a fluorescent image panel previously attached to the apparatus itself has been changed to a higher level, it is changed to a lower level. For this reason, an operator can clearly visually recognize changes in the brightness of the information displayed on the fluorescent tube and so surely recognize that the remote controller control command has been received.

In the invention described in claim 5, in order to change the brightness level of the information being displayed on the fluorescent image panel, a part of the control program to be executed by the control unit has only to be changed to create the display-driver brightness-up command and the display-driver brightness-down command. No addition of the circuit is required, thus giving rise to no increase in the production cost.

### BRIEF DESCRIPTION OF THE DRAWINGS

FIG. 1 is a block diagram showing a video signal playback system according to an embodiment of this invention;

FIG. 2 is a flowchart showing the control processing of recognition/display of whether or not a remote controller control command has been received in the above video signal playback system; and

FIG. 3 is a flowchart showing the control processing of recognition/display of whether or not a remote controller control command has been received in a video signal playback system according to another embodiment of this invention.

### DETAILED DESCRIPTION OF THE INVENTION

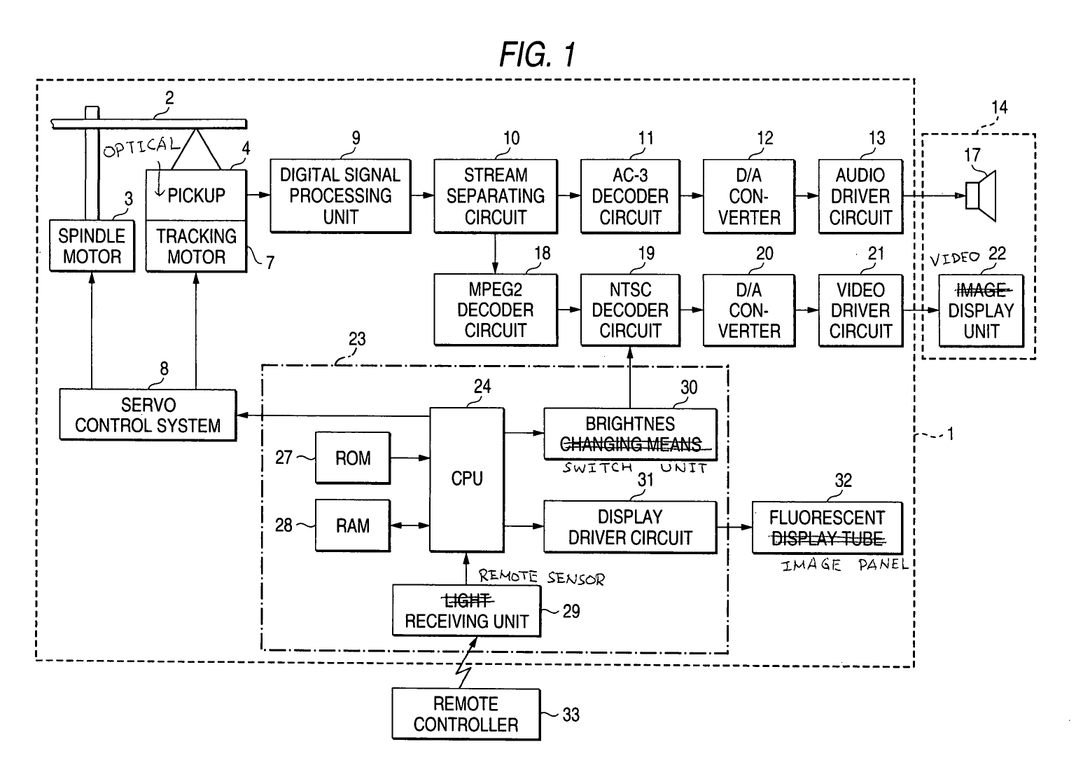

Now referring to the drawings, an explanation will be given of various preferred embodiments of this invention. FIG. 1 is a block diagram of a video signal playback system 1 according to an embodiment of this invention. In this embodiment, an example of a DVD player is illustrated. Referring to FIG. 1, while a recording medium 2 of DVD is rotated by a spindle motor 3, the recorded data on itself is read out by an optical pickup 4. The pickup 4 is moved in a disk-radial-direction of the recording medium 2 by a tracking motor 7. The tracking motor 7 and spindle motor 3 are rotation-controlled by a servo control system 8.

An RF signal, which is the recorded data read out by the pickup 4 on the basis of the strength of the light reflected from the recording medium 2, after it has been converted into a digital data by an RF amplifier not shown, is supplied to a digital signal processing unit 9. The digital signal processing unit 9 subjects the received digital data to the processing such as error correction. The resultant data is supplied to a stream separating circuit 10.

The stream separating circuit 10 separates the digital data supplied from the digital signal processing unit 9 into the respective bit streams of video and audio sub-pictures. The audio bit stream separated is supplied to an AC-3 decoder circuit 11. The audio bit stream has been compression-encoded in an AC-3 format. The AC-3 decoder circuit 11 extends the audio bit stream and subjects it to decoding processing so that the audio bit stream is converted into a digital audio signal.

The digital audio signal thus acquired is supplied from the AC-3 decoder 11 to a D/A converter 12. Thus, the digital audio signal is converted into analog audio signal. The resulting analog audio signal is supplied to a speaker 17 of a television receiver 14 through an audio driver circuit 13. As a result, this audio analog signal is reproduced and outputted as audible voice from the speaker 17.

On the other hand, the video bit stream separated in the stream separating circuit 10 is supplied to an MPEG2 decoder circuit 18. This video bit stream has been compression-encoded in a MPEG3 format. The MPEG2 decoder circuit 18 extends the video bit stream and subjects it to decoding processing so that the video bit stream is converted into a digital video signal. This digital video signal is supplied to an NTSC decoder circuit 19. The NTSC decoder circuit 19 converts the received digital video signal into a digital video signal representing a picture in an NTSC standard. The digital video signal thus acquired is converted into an analog video signal by a D/A converter 20. The resultant analog video signal is outputted onto a video display unit 22 such as a CRT tube, liquid-crystal display panel or plasma display panel of the television receiver 14 and image-displayed on the video display unit 22.

A system controller 23 controls the entire apparatus on the basis of various remote controller control commands inputted through a key operation of a remote controller 33 by an operator. Specifically, a CPU 24 of the system controller 23 reads out various control programs and application programs stored in a ROM 27 by receiving the remote controller control command transmitted as an infrared ray signal from the remote controller 33 and temporarily stores these programs in a program storage region within a RAM 28. Further, the CPU 24 executes various kinds of control processing designated by the remote controller control command and temporarily stores the various data produced in this control processing in the RAM 28.

For example, when the CPU 24 receives the remote controller control command of a reproduction command from the remote controller 33, it rotation-controls the spindle motor 3 and tracking motor 7 through the servo control system 8. Thus, the pickup 4, while it is being moved outwardly in a disk-radial direction from the disk innermost periphery of the recording medium 2, reads the recorded data from the start of data region of the recording medium 2. Further, the video signal playback system 1 is provided with a fluorescent image panel 32 on which the status of the apparatus, e.g. various status such as usual reproduction, fast-forward reproduction and rewinding is displayed by a character, code and mark. The CPU 24 of the system controller 23 commands a display driver circuit 31 to control the display of the fluorescent image panel 32.

The above configuration is an existing configuration with which the ordinary video signal playback system 1 is inherently provided. This embodiment is characterized in that it is newly provided with a brightness switch unit 30 which supplies a video signal brightness changing command to the NTSC decoder circuit 19 by changing a part of the control program stored in the ROM 27, thereby changing the brightness of the digital video signal. Thus, the brightness switch unit 30 is not constructed in hardware configuration, but is a software function means which provides a function of creating the video signal brightness changing command by changing a part of the control program. Namely, this video signal playback system 1 uses the existing hardware configuration as it is without adding any circuit to the existing configuration, and hence does not almost increase the production cost as compared with a conventional apparatus.

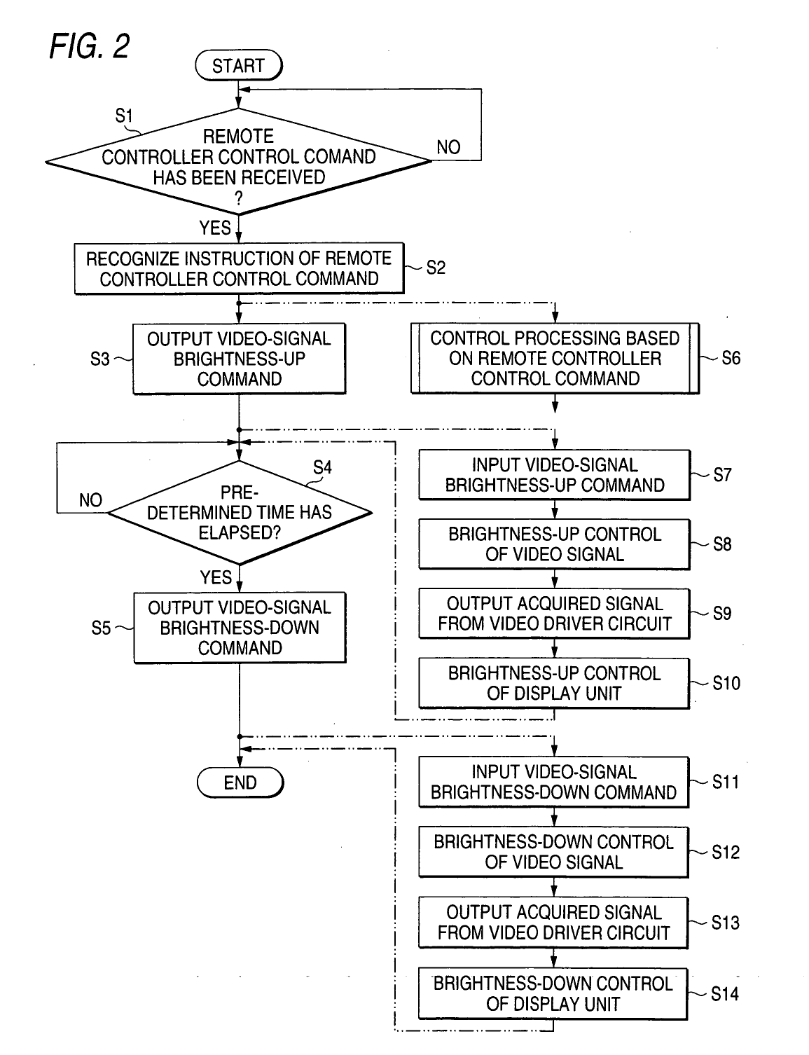

Next referring to the flowchart of FIG. 2, an explanation will be given of the control processing of recognition/display of whether or not the remote controller control command has been received in the above video signal playback system. Incidentally, the control processing outside the system controller 23 is illustrated in such a manner that the corresponding control flow is connected in two-dot chain line. The CPU 24 of the system controller 23 monitors all the time whether or not the remote controller control command transmitted from the remote controller 33 has been received by the remote sensor receiving unit 29 (step S1). If the CPU 24 determines that the remote controller control command has been received, it recognizes the command contents (or instruction) of the remote controller control command and controls the entire apparatus on the basis of the instruction (step S6), and also supplies a video signal brightness-up (increase) command through the brightness switch unit 30 to the NTSC decoder circuit 19 (step S3).

At this time, in the NTSC decoder circuit 19, when it has supplied with the video signal brightness-up command (step S7), the control processing of increasing the brightness level of the digital video signal (step S8) has been executed. The signal thus acquired is supplied to the video display unit 22 of the television receiver 14 from an analog output terminal (not shown) through the video driver circuit 21 (step S9). Thus, the brightness of the image being displayed on the video display unit 22 of the television receiver 14 becomes higher than a normal level (step S10). Accordingly, the operator of the remote controller 33 can clearly recognize that the image has abruptly become bright.

The CPU 24 monitors whether or not a predetermined time e.g. one second has elapsed from when it has supplied the video signal brightness-up command to the NTSC decoder circuit 19 (step S4). If the CPU 24 determines that one second has elapsed, it supplies a video signal brightness-down (decrease) command to the NTSC decoder circuit 19 through the brightness switch unit 30 (step S5).

At this time, in the NTSC decoder circuit 19, when it has supplied with the video signal brightness-down command (step S11), the control processing of decreasing the brightness level of the digital video signal (step S12) is executed. The signal thus acquired is supplied to the video display unit 22 of the television receiver 14 through the video driver circuit 21 (step S13). Thus, the brightness of the image being displayed on the video display unit 22 of the television receiver 14 abruptly lowers from the above high level to a level lower than the normal level (step S14). Accordingly, the operator of the remote controller 33 can clearly recognize that the image has abruptly become dark.

As a result, in the above video signal playback system 1, a part of the control program of the system controller 23 is only changed. And in the video signal playback system 1, a low-cost configuration using the existing configuration as hardware is adopted, and also whenever the remote controller control command is received from the remote controller 33, the brightness level of the image being displayed on the video display unit 22 is changed to a higher level than the normal level and thereafter to a lower level than the normal level. Thus, the operator can clearly visually recognize a change in the brightness of the image on the video display unit 22 and so can surely recognize that the remote controller control command has been received. Further, by changing the brightness level of the image being displayed on the video display unit 22 of the television receiver 14, this video signal playback system 1 permits the operator to surely recognize that the remote controller control command has been received. Thus, the operator pays attention to subsequent changes in an image or voice on the display screen of the video display unit 22. As a result, omission of the “on-screen-display function” gives rise to no trouble.

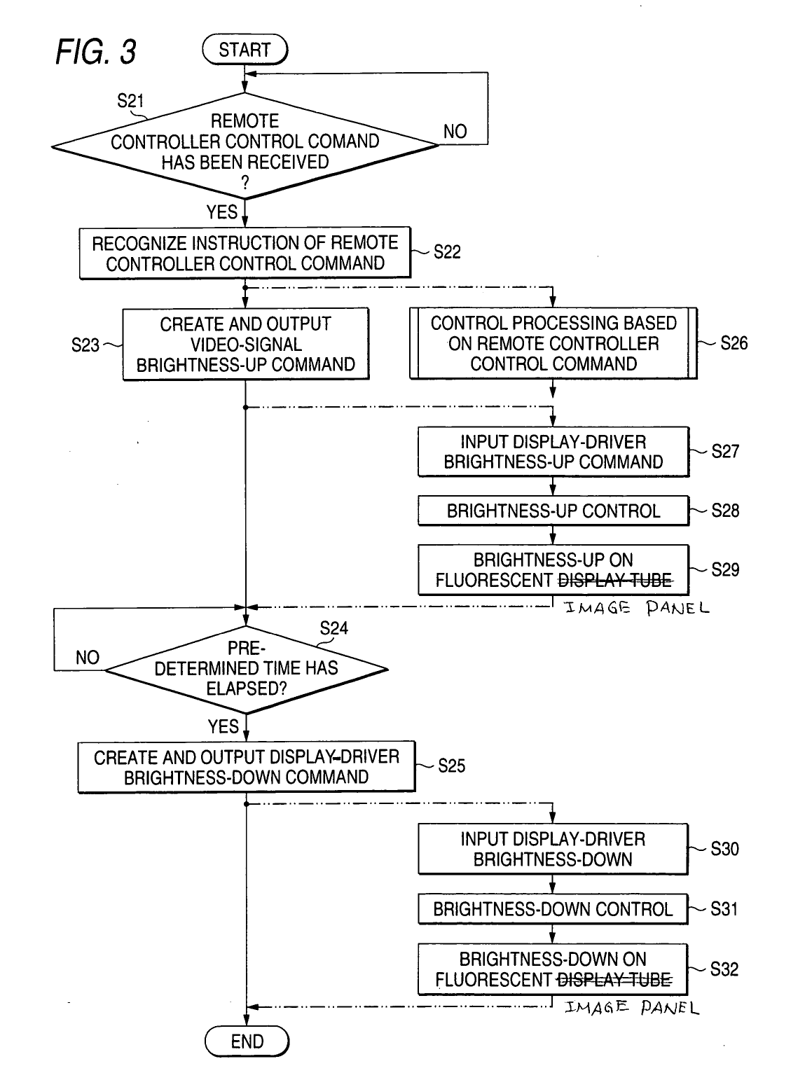

FIG. 3 is a flowchart showing the control processing of recognition/display of whether or not the remote controller control command has been received in the above video signal playback system according to another embodiment of this invention. In this embodiment, in place of changing the brightness of the image displayed on the video display unit 22 of the television receiver 14 according to the above embodiment, the brightness of the information displayed on the fluorescent image panel 32 previously attached to the playback system 1 is changed. Incidentally, in FIG. 3, the control processing outside the system controller 23 is illustrated in such a manner that the corresponding control flow is connected in two-dot chain line.

In FIG. 3, the CPU 24 of the system controller 23 monitors all the time on whether or not the remote controller control command transmitted from the remote controller 33 has been received by the remote sensor receiving unit 29 (step S21). If the CPU 24 determines that the remote controller control command has been received, it recognizes the command contents (or instruction) of the remote controller control command and controls the entire apparatus on the basis of the instruction (step S26), and also creates a display-driver brightness-up (increase) command and supplies it through the brightness switch unit 30 and to a display driver circuit 31 (step S23) At this time, in the display driver circuit 31, when it has supplied with the above display-driver brightness-up command (step S27), the control processing of increasing the brightness level of the display signal (step S8) is executed. Thus, the brightness of the image being displayed on the fluorescent image panel 32 becomes higher than a normal level (step S10). Accordingly, the operator of the remote controller 33 can clearly recognize that the image has abruptly become bright.

The CPU 24 monitors whether or not a predetermined time e.g. one second has elapsed from when it has supplied the display-driver brightness-up command to the display driver circuit 31 (step S24). If the CPU 24 determines that one second has elapsed, it supplies a display-driver brightness-down (decrease) command to the display driver circuit 31 from the brightness switch unit 30 (step S25).

At this time, in the display driver circuit 31, when it has supplied with the display-driver brightness-down command (step S30), the control processing of decreasing the brightness level of the displayed signal (step S31) is executed. Thus, the brightness of the image being displayed on the fluorescent image panel 32 abruptly lowers from the above high level to a level lower than the normal level (step S32). Accordingly, the operator of the remote controller 33 can clearly recognize that the image has abruptly become dark.

As a result, in the above video signal playback system 1 also, a part of the control program of the system controller 23 is only changed. And in the video signal playback system 1, a low-cost configuration using the fluorescent image panel 32 previously attached to the playback system 1 is adopted, and also whenever the remote controller control command is received from the remote controller 33, the brightness level of the image being displayed on the image fluorescent image panel 32 is changed to a higher level than the normal level and thereafter to a lower level than the normal level. Thus, the operator can clearly visually recognize a change in the brightness of the image on the fluorescent image panel 32 and so can surely recognize that the remote controller control command has been received.

Additionally, if both recognition/display functions in both embodiments described above are used, i.e. both brightness levels of the displayed image on the video display unit of the television receiver 14 and of the displayed information on the fluorescent image panel 32 are simultaneously changed, the operator can be caused to recognize further surely that the remote controller control command has been received. In this case also, a part of the control program of the system controller 23 is only changed, and newly adding any circuit as hardware is not required, thereby almost not increasing the production cost as compared with the existing playback system.

The video signal playback system according to this invention permits the operator to surely visually recognize that the remote controller control command has been received in such a manner that when the remote controller control command is received, brightness level control is made to change the brightness of the image being displayed on the video display unit of the television receiver or monitor device to which this video signal playback system is connected or the information being displayed on the fluorescent image panel previously attached thereto. Therefore, in accordance with this invention, there can be provided the video signal playback system realized in a low-cost configuration without adding any hardware such as a circuit to the existing configuration and provided with the function of permitting the operator to surely recognize that the remote controller control command has been received.

1. A video signal playback system for reproducing recorded data read out from a recording medium to image-display a video signal of the recorded data on a video display unit of a television receiver or a monitor device, comprising:
a remote sensor receiving unit that receives a remote controller control command transmitted as an optical signal from a remote controller;
a main body display unit that displays a status of the apparatus; and
a control unit that controls the entire apparatus on a basis of an instruction by the remote controller control command, wherein
the control unit has at least one of a flashing controlling function of changing a brightness level of an image being displayed on the video display unit to at least one of higher and lower levels than its normal level, or another flashing controlling function of changing a brightness level of information being displayed on the main body display unit to at least one of higher and lower levels than its normal level whenever the control unit detects an input of the remote controller control command.

2. The video signal playback system according to claim 1, wherein
the main body display unit is a fluorescent image panel or a liquid crystal display panel.

3. A video signal playback system for reproducing recorded data read out from a recording medium to image-display a video signal of the recorded data on a video display unit of a television receiver or a monitor device, comprising:
a remote sensor receiving unit that receives a remote controller control command transmitted as an optical signal from a remote controller; and
a control unit that controls the entire apparatus on a basis of an instruction by the remote controller control command, wherein
the control unit has a flashing controlling function of changing a brightness level of an image being displayed on the video display unit to at least one of higher and lower levels than its normal level whenever the control unit detects an input of the remote controller control command.

4. The video signal playback system according to claim 3, wherein
the control unit sequentially creates a video signal brightness-up command or a video signal brightness-down command to be supplied to a decoder circuit.

5. A video signal playback system for reproducing recorded data read out from a recording medium to image-display a video signal of the recorded data on a video display unit of a television receiver or a monitor device, comprising:
a remote sensor receiving unit that receives a remote controller control command transmitted as an optical signal from a remote controller;
a main body display unit that displays a status of the apparatus; and
a control unit that controls the entire apparatus on a basis of an instruction by the remote controller control command, wherein
the control unit has a flashing controlling function of changing a brightness level of information being displayed on the main body display unit to at least one of higher and lower levels than its normal level whenever the control unit detects an input of the remote controller control command.

6. The video signal playback system according to claim 5, wherein
the main body display unit is a fluorescent image panel or a liquid crystal display panel.

7. The video signal playback system according to claim 5, wherein
the control unit sequentially creates a display-driver brightness-up command or a display-driver brightness-down command to be supplied to a display driver circuit for display-controlling the main body display unit.

8. A video signal reproducing method for reproducing recorded data read out from a recording medium to image-display a video signal of the recorded data on a video display unit of a television receiver or a monitor device, comprising:
receiving a remote controller control command transmitted as an optical signal from a remote controller;
displaying on a main body display unit a status of an apparatus; and
controlling the entire apparatus on a basis of an instruction by the remote controller control command, wherein whenever an input of the remote controller control command is detected, the controlling includes:
flashing controlling changing a brightness level of an image being displayed on the video display unit to at least one of higher and lower levels than its normal level; and
flashing controlling changing a brightness level of information being displayed on the main body display unit to at least one of higher and lower levels than its normal level.
